(19) United States
(12) Patent Application Publication
(10) Pub. No.: US 2019/0116426 A1
(43) Pub. Date: Apr. 18, 2019

(54) Loudspeaker Driver/Exciter with Unique Design to Facilitate Mounting

(71) Applicants: Harish Bhutani, Cerritos, CA (US); Gerardo Claustro, Azusa, CA (US)

(72) Inventors: Harish Bhutani, Cerritos, CA (US); Gerardo Claustro, Azusa, CA (US)

(73) Assignee: Monaero Engineering, Inc., La Mirada, CA (US)

(21) Appl. No.: 15/783,324

(22) Filed: Oct. 13, 2017

(51) Int. Cl. H04R 9/06; H04R 9/04

(52) U.S. Cl. CPC H04R 9/063; H04R 9/045

(57) ABSTRACT

A loudspeaker driver/exciter assembly for use with any flat or slightly contoured surface panel. The invention is composed of a driver assembly, a frame, and a voice coil exciter assembly. The driver assembly includes magnet, core cap, and shell pot. The voice coil exciter assembly includes a former, coil and exciter assembly. A spider suspends the voice coil exciter assembly below the driver assembly. The invention is mounted to the panel by one or more interfaces between the frame and the panel and one or more interfaces between the exciter and the panel. One or more holes or cutouts are provided in the shell pot, core cap, and magnet, and aligned with the screws or fasteners of the voice coil exciter assembly in such a way that a tool such as a screwdriver may be used to facilitate quick and easy mounting and removal of the driver/exciter assembly with the panel.

Loudspeaker driver/exciter assemblies today come in different configurations. The common driver/exciter is coupled to a surface of a panel by the use of either bonding or mechanical fastening the basket frame of the assembly to the panel. In addition the movement of the exciter is transferred to the panel by bonding or mechanically fastening a vibration plate to the panel. If bonding is the preferred method, then replacement of the driver/exciter assembly is nearly impossible and the entire panel may need to be replaced. If mechanical fastening is the preferred method, then the driver/exciter is replaceable but there are usually 3 to 4 fasteners used for the basket and 3 to 4 fasteners used for the exciter to panel attachment. This use of multiple hardware fasteners leads to added weight in the system which in turn causes additional work for the moving features of the driver/exciter assembly.

### SUMMARY OF THE INVENTION

The present invention of a loudspeaker driver/exciter assembly aims to allow the replacement of the assembly quickly and with minimal hardware thus reducing weight and time for installation and removal. The assembly may include a support frame, shell pot, magnet, core cap, spider, coil and exciter pad. The assembly may be uniquely configured to allow mechanical attachment of both the support frame and the exciter insert to a panel with minimal hardware.

### BRIEF DESCRIPTION OF THE DRAWINGS

The foregoing and other objects, features and advantages of the invention, will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention. Moreover, in the figures, like referenced numerals designate corresponding parts throughout the different views.

FIG. 1 is a perspective view of a driver/exciter assembly according to an embodiment of the present invention and an example of a method of the attachment to a thick panel.

FIG. 2 is another example of a method of the attachment of the driver/exciter assembly to a thin panel.

FIG. 3 is a top view, side view and cross-sectional cut of the driver/exciter assembly.

### DETAILED DESCRIPTION OF THE INVENTION

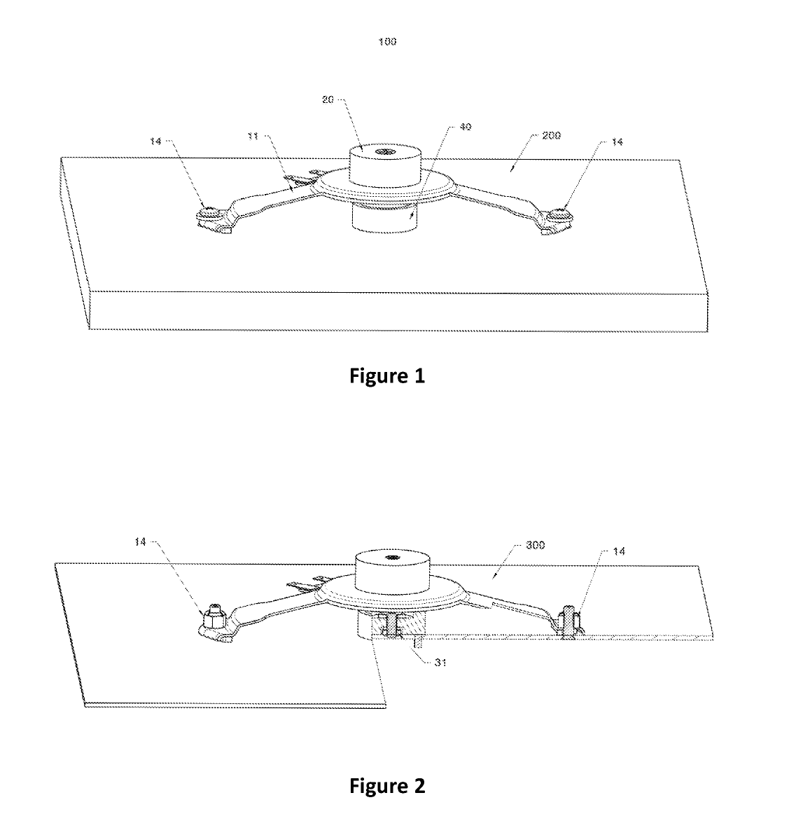

FIG. 1 is an illustration of an the present invention, a loudspeaker driver/exciter assembly 100, showing a rigid support frame 11, a driver assembly 20 and a voice coil exciter assembly 40 with integral attach hardware 14 to attach both the frame 11 and the voice coil exciter assembly 40 to a panel 200.

FIG. 2 is an illustration on how the present invention 100, may be coupled to panel 300 by the use of attach hardware 14 and fasteners 31 that are pressed clinched into a metallic material panel 300.

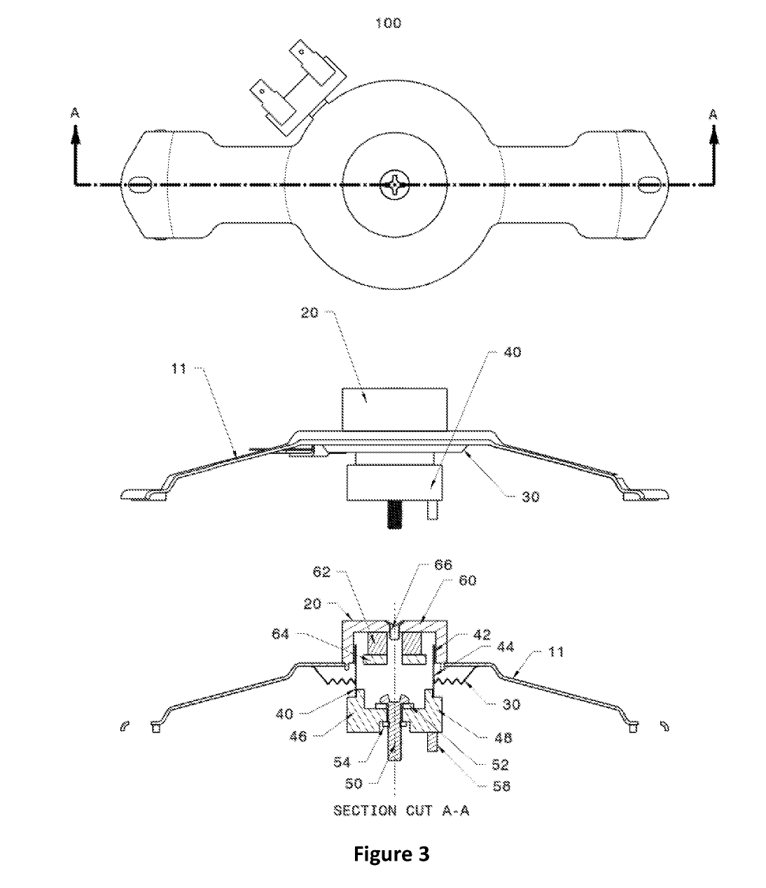

FIG. 3 is a top view, side view and section cut of the loudspeaker driver/exciter assembly 100; it may include a voice coil exciter assembly 40 and a driver assembly 20. In an embodiment, the driver assembly 20 consist of a shell pot 60 with center access hole that is installed into the support frame 11, a magnet 62 with center access hole, bonded to the shell pot 60 and a core cap 64 with center access hole bonded to the magnet 62. A screw 66 may be used to close out the access hole in the shell pot 60 to prevent foreign objects from entering the assembly. The voice coil exciter assembly 40 may include a coil 42, a former 44 and an exciter assembly 46. The exciter assembly 46 may include an exciter pad 48, attachment screw 50, washer 52 and a retaining clip 54. The exciter pad 48 has a centralized hole to allow the assembly of the attachment screw 50, washer 52 and retaining clip 54. The exciter pad 48 has a pin 58 feature that will be used as a clocking mechanism to insure the loudspeaker driver/exciter assembly is mounted onto the panel in one orientation only. The coil 42 and exciter pad 48 is bonded to the former 44. The voice coil exciter assembly 40 may be suspended and centered in relation to the driver assembly 20 by a spider 30. This spider 30 allows for the movement of the voice coil exciter assembly 40 which in turns creates movement in the surface of the panel 200, FIG. 1. The alignment of the center access holes in the shell pot 60, magnet 62 and the core cap 64 is in line with the attachment screw of the exciter assembly 46 to allow a tool such as a screwdriver may be used to easily and quickly facilitate mounting and removal of the driver/exciter assembly to and from the panel.

1. An loudspeaker driver/exciter assembly that can be uniquely coupled to the surface of a panel, the loudspeaker driver/exciter assembly consisting of:
a. A support frame, a driver assembly and a voice coil exciter assembly.
b. The driver assembly consists of a shell pot, magnet and core cap.
c. The voice coil exciter assembly consists of a former, coil, exciter pad and attachment hardware.
d. A spider which suspends and centers the voice coil exciter assembly in relation to the driver assembly.

2. The driver assembly of claim 1 which is comprised of a shell pot, magnet and core cap that all have a centralized access hole in their construction and assembly.

3. The voice coil exciter assembly of claim 1 which is comprised of a coil former, coil copper windings, and exciter pad and retained attachment hardware.

4. The exciter pad of claim 3 which has a centralized access hole in its construction to allow retained assembly of attachment hardware.

5. The coupling of the loudspeaker driver/exciter assembly to a panel is accomplished at both the support frame legs and the exciter pad of the voice coil exciter assembly because the center of the driver assembly is aligned with an internal screw or fastener of the voice coil exciter assembly in such a way that a tool such as a screwdriver may be used to facilitate mounting and removal of the voice coil exciter to and from the panel using the retained hardware of claim 3.

6. The shell pot hole of claim 2 is threaded so a screw may be assembled to it to prevent any foreign object debris from entering the loudspeaker driver/exciter assembly.
